(19) United States
(12) Patent Application Publication
(10) Pub. No.: US 2010/0253655 A1
(43) Pub. Date: Oct. 7, 2010

(54) PLASMA DISPLAY DEVICE

(76) Inventors: Mitsuhiro Murata, Hyogo (JP); Kaname Mizokami, Kyoto (JP); Toshikazu Wakabayashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/598,835

(22) PCT Filed: Apr. 13, 2009
(86) PCT No.: PCT/JP2009/001683

§ 371 Date: Nov. 4, 2009

(30) Foreign Application Priority Data
Apr. 18, 2008 (JP) 2008-108593

(51) Int. Cl. G09G 5/00

(52) U.S. Cl. 345/204; 345/60

(57) ABSTRACT

A protective layer of a plasma display panel has a base protective layer formed of a thin film containing metal oxide, and a particle layer formed by sticking, to the base protective layer, agglomerated particles where single crystal particles of magnesium oxide are agglomerated. A panel driving circuit drives the panel by forming one field period by temporally arranging a second subfield group after a first subfield group. The first subfield group has subfields having initializing period Ti for producing wall charge for causing an address discharge, address period Tw for producing wall charge for causing a sustain discharge, and sustain period Ts for causing a sustain discharge to emit light in the discharge cells. The second subfield group has subfields having address period Tw for erasing wall charge for causing a sustain discharge and sustain period Ts for causing a sustain discharge to emit light in the discharge cells.

### TECHNICAL FIELD

The present invention relates to a plasma display device as an image display device using a plasma display panel.

### BACKGROUND ART

A plasma display panel (hereinafter referred to as “panel”), among thin image display elements, allows high speed display and can be easily enlarged, so that the panel becomes commercially practical as a large-screen display device.

The panel is formed by sticking a front plate to a back plate. The front plate has the following elements:
a glass substrate;
display electrode pairs that are disposed on the glass substrate and each of which is formed of a scan electrode and a sustain electrode;
a dielectric layer formed so as to cover the display electrode pairs; and
a protective layer formed on the dielectric layer.
   The protective layer protects the dielectric layer from ion collision and facilitates discharge.

The back plate has the following elements:
a glass substrate;
data electrodes formed on the glass substrate;
a dielectric layer for covering the data electrodes;
barrier ribs formed on the dielectric layer; and
phosphor layers that are disposed between the barrier ribs and emit red, green, and blue lights, respectively.
   The front plate and back plate are faced to each other so that the display electrode pairs intersect with the data electrodes while discharge space is sandwiched, and their periphery is sealed with low-melting glass. Discharge gas containing xenon is filled into the discharge space. Discharge cells are formed in the parts where the display electrode pairs face the data electrodes.

In a plasma display, device using the panel having this structure, a gas discharge is selectively caused in respective discharge cells of the panel, ultraviolet rays generated at this time excite red, green, and blue phosphors to emit lights, and thus color display is attained.

As a method of displaying an image with the plasma display device using such a panel, a subfield method is mainly used. In this method, one field period is formed of a plurality of subfields of a predetermined luminance weight, light emission and no light emission of each discharge cell is controlled in each subfield to display an image.

When the lighting and no lighting of each discharge cell is performed arbitrarily in each subfield, however, significant gradation turbulence of a contour shape, the so-called false contour, can occur in a displayed moving image. A method of suppressing the false contour is disclosed in Patent literature 1, for example. In this method, the false contour is suppressed by displaying gradation by performing the control so that subfields in which the discharge cell undergoes light emission are successively disposed and subfields in which discharge cell undergoes no light emission are also successively disposed. Such a display method can suppress the occurrence of a false contour, but displaceable gradation is restricted and display of smooth gradation is difficult, disadvantageously.

In order to display smooth gradation, the number of subfields forming one field period is required to be increased. In the above-mentioned subfield method, one field period is formed of a plurality of subfields, and the subfields in which light is emitted are combined, thereby performing gradation display. Each subfield has an initializing period, an address period, and a sustain period. In order to increase the number of subfields forming one field period, an address operation needs to be performed within a short period. For this purpose, a panel capable of being driven at a high speed has been developed, and a driving method and driving circuit for displaying a high-quality image using the feature of the panel have been studied.

The discharge characteristic of the panel largely depends on the characteristic of the protective layer. Especially, in order to improve the electron emission performance and charge retention performance that affect the possibility of the high speed driving, the material, structure, and manufacturing method of the protective layer have been studied widely. Patent literature 2, for example, discloses a plasma display device having the following elements:
a panel having a magnesium oxide layer that is produced by gas phase oxidation of magnesium vapor and has a cathode luminescence emission peak at a wavelength of 200 to 300 nm; and
an electrode driving circuit for sequentially applying scan pulses to one electrode of each of the display electrode pairs forming all display lines in the address period and applying, to the data electrode, the address pulse corresponding to the display line to be applied with the scan pulse.

Recently, a plasma display device having a large screen and high definition has been demanded, and high quality of image display has been also demanded. Thus, in addition to increase of the number of lines, the number of subfields for displaying the smooth gradation needs to be secured. Therefore, the time assigned to the address operation per line is apt to become increasingly shorter. In order to perform a certain address operation within the assigned time, a plasma display device is demanded that has a panel allowing stabler and higher-speed address operation than that of the conventional art, its driving method, and a driving circuit for achieving it.

[Patent Literature 1] Unexamined Japanese Patent Publication No. 1111-305726

[Patent Literature 2] Unexamined Japanese Patent Publication No. 2006-54158

### SUMMARY OF THE INVENTION

The plasma display device of the present invention has a panel and a panel driving circuit. The panel has the following elements:
a front plate having display electrode pairs on a first glass substrate, a dielectric layer for covering the display electrode pairs, and a protective layer on the dielectric layer;
a back plate that faces the front plate and has data electrodes on a second glass substrate; and
discharge cells formed at the positions where the display electrode pairs face the data electrodes.
   The panel driving circuit drives the panel while a plurality of subfields are temporally disposed to form one field period. The protective layer has a base protective layer formed of a thin film of metal oxide, and a particle layer formed by sticking, to the base protective layer, agglomerated particles formed by agglomerating a plurality of single crystal particles of magnesium oxide. The panel driving circuit drives the panel while a second subfield group is temporally disposed after a first subfield group to form one field period. Here, the first subfield group has a plurality of subfields each of which has an initializing period for producing wall charge for causing an address discharge, an address period for producing wall charge for causing a sustain discharge, and a sustain period for causing a sustain discharge to make a discharge cell emit light. The second subfield group has a plurality of subfields each of which has an address period for erasing the wall charge for causing a sustain discharge and a sustain period for causing a sustain discharge to make a discharge cell emit light.

### BRIEF DESCRIPTION OF DRAWINGS

FIG. 1 is a perspective view showing a structure of a panel in accordance with an exemplary embodiment of the present invention.

FIG. 2 is a sectional view showing a structure of a front plate of the panel.

FIG. 3 is a diagram showing an example of agglomerated particles of the panel.

FIG. 4 is a diagram showing the electron emission performance and charge retention performance of trial panels including the panel.

FIG. 5A is a diagram showing a result of an experiment where the diameters of single crystal particles of the trial panels are changed and the electron emission performance is investigated.

FIG. 5B is a diagram showing the relation between the diameters of the single crystal particles of the trial panels and breakage of barrier ribs.

FIG. 6 is a diagram showing an electrode array of the panel in accordance with an exemplary embodiment of the present invention.

FIG. 7 is a waveform chart of driving voltage applied to each electrode of the panel.

FIG. 8 is a waveform chart of driving voltage applied to each electrode of the panel.

FIG. 9 is a circuit block diagram of a plasma display device in accordance with the exemplary embodiment of the present invention.

FIG. 10 is a circuit diagram of a scan electrode driving circuit and a sustain electrode driving circuit of the plasma display device.

### REFERENCE MARKS IN THE DRAWINGS

10 panel
20 front plate
21 (first) glass substrate
22 scan electrode
22a, 23a transparent electrode
22b, 23b bus electrode
23 sustain electrode
24 display electrode pair
25, 33 dielectric layer
26 protective layer
26a base protective layer
26b particle layer
27 single crystal particle
28 agglomerated particle
30 back plate
31 (second) glass substrate
32 data electrode
34 barrier rib
35 phosphor layer
41 image signal processing circuit
42 data electrode driving circuit
43 scan electrode driving circuit
44 sustain electrode driving circuit
45 timing generating circuit
50, 80 sustain pulse generating circuit
60 initializing waveform generating circuit
70 scan pulse generating circuit
100 plasma display device

### DETAILED DESCRIPTION OF PREFERRED EMBODIMENTS

A plasma display device in accordance with an exemplary embodiment of the present invention will be described hereinafter with reference to the accompanying drawings.

### Exemplary Embodiment

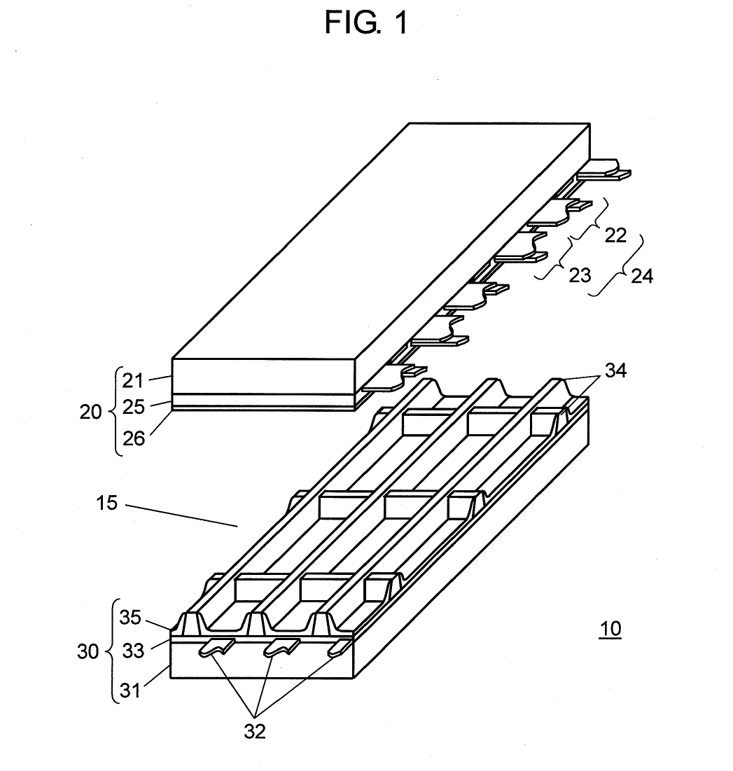

FIG. 1 is a perspective view showing a structure of panel 10 in accordance with an exemplary embodiment of the present invention. In panel 10, front plate 20 and back plate 30 are faced to each other, and their periphery is sealed with a sealing material made of low-melting glass. Discharge gas such as xenon is filled at a pressure of 400 to 600 Torr into discharge space 15 in panel 10.

A plurality of display electrode pairs 24 each of which is formed of scan electrode 22 and sustain electrode 23 are disposed in parallel on glass substrate (first glass substrate) 21 of front plate 20. Dielectric layer 25 is formed on glass substrate 21 so as to cover display electrode pairs 24, and protective layer 26 mainly made of magnesium oxide is formed on dielectric layer 25.

A plurality of data electrodes 32 are disposed in parallel in the direction orthogonal to display electrode pairs 24 on glass substrate (second glass substrate) 31 of back plate 30, and are covered with dielectric layer 33. Barrier ribs 34 are disposed on dielectric layer 33. Phosphor layers 35 for emitting red, green, blue lights with ultraviolet rays are formed on dielectric layer 33 and on side surfaces of barrier ribs 34, respectively. Discharge cells are formed at the intersecting positions of display electrode pairs 24 and data electrodes 32, and a set of discharge cells having phosphor layers 35 for red, green, and blue form a pixel for color display. Dielectric layer 33 is not essential, but a structure having no dielectric layer 33 may be employed.

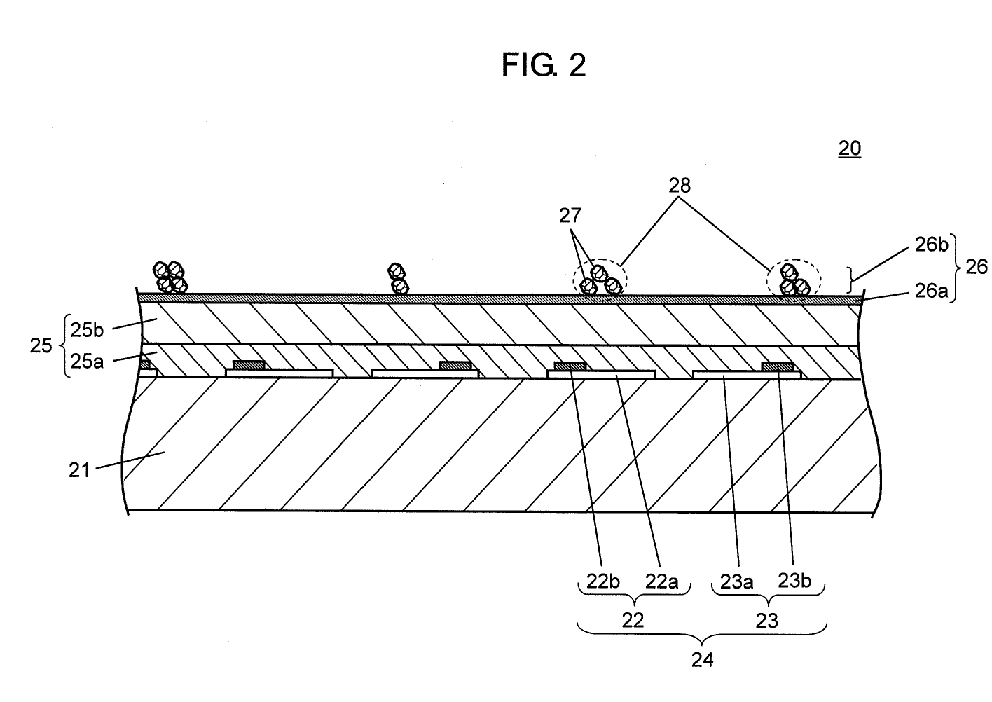

FIG. 2 is a sectional view showing a structure of front plate 20 of panel 10 in accordance with the exemplary embodiment of the present invention, and is illustrated by turning front plate 20 of FIG. 1 upside down. Display electrode pairs 24 formed of scan electrodes 22 and sustain electrodes 23 are disposed on glass substrate 21. Each scan electrode 22 has transparent electrode 22a made of indium tin oxide or tin oxide, and bus electrode 22b disposed on transparent electrode 22a. Similarly, sustain electrode 23 has transparent electrode 23a, and bus electrode 23b disposed on it. Bus electrode 22b and bus electrode 23b are disposed for applying conductivity in the longitudinal direction of transparent electrode 22a and transparent electrode 23a, and are made of a conductive material mainly containing silver.

Dielectric layer 25 has a two-layer structure formed of first dielectric layer 25a and second dielectric layer 25b. First dielectric layer 25a is formed to cover transparent electrodes 22a, transparent electrodes 23a, bus electrodes 22b, and bus electrodes 23b. Second dielectric layer 25b is formed on first dielectric layer 25a. However, dielectric layer 25 does not need to have a two-layer structure, but may be structured to have a single-layer structure or a three-or-more-layer structure.

Protective layer 26 is formed on dielectric layer 25. Protective layer 26 is hereinafter described in detail. Protective layer 26 protects dielectric layer 25 from ion collision, and improves the electron emission performance and charge retention performance that significantly affect the driving speed. For this purpose, protective layer 26 is formed of base protective layer 26a disposed on second dielectric layer 25b and particle layer 26b disposed on base protective layer 26a.

Base protective layer 26a is a thin film mainly made of magnesium oxide, and its thickness is 0.3 to 1.0 μm, for example.

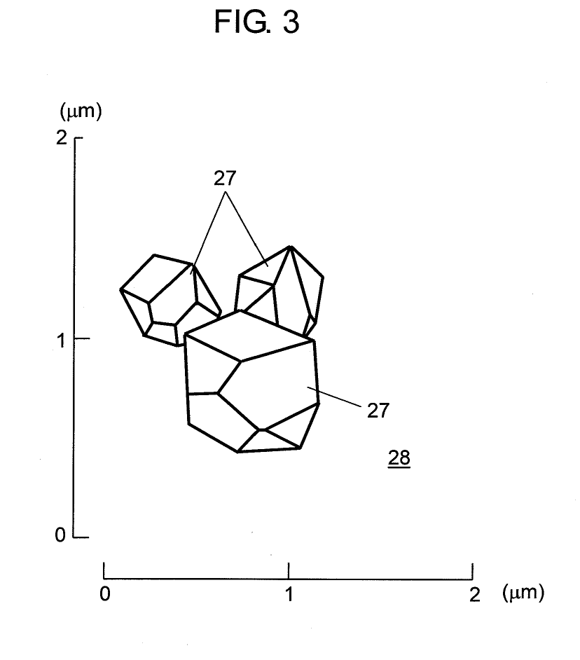

Particle layer 26b is formed by discretely sticking agglomerated particles 28 to base protective layer 26a so that the agglomerated particles are distributed substantially uniformly over the whole surface thereof. Here, agglomerated particles 28 are formed by agglomerating a plurality of single crystal particles 27 of magnesium oxide. In FIG. 2, agglomerated particles 28 are enlarged. FIG. 3 is a diagram showing an example of agglomerated particles 28 of panel 10 in accordance with the exemplary embodiment of the present invention. Agglomerated particles 28 are in a state where single crystal particles 27 are agglomerated or necked as shown in FIG. 3. The plurality of single crystal particles 27 are formed into an aggregate by static electricity or van der Waals force. Preferably, single crystal particles 27 have a polyhedron shape having seven or more faces, such as a tetradecahedron and dodecahedron, and have a particle diameter of about 0.9 to 2.0 μm. Preferably, in agglomerated particles 28, two to five single crystal particles 27 are agglomerated. Preferably, agglomerated particles 28 have a diameter of about 0.3 to 5 μm.

Single crystal particles 27 satisfying the above-mentioned conditions and agglomerated particles 28 formed by agglomerating the single crystal particles can be produced in the following manner. When a magnesium oxide precursor, such as magnesium carbonate or magnesium hydroxide, is fired to provide the particles, the particle diameter can be controlled to about 0.3 to 2 μm by setting the firing temperature at a relatively high temperature of 1000° C. or higher. Further, firing the magnesium oxide precursor can provide agglomerated particles 28 in which single crystal particles 27 are agglomerated or necked with each other.

Next, an effect of protective layer 26 is described. In order to recognize the effect of protective layer 26 of the exemplary embodiment, trial panels that include three types of protective layers having different structures are produced, and the discharge characteristics thereof are examined. The first type of trial panels include a protective layer that has only base protective layer 26a of a thin film mainly made of magnesium oxide. In the second type of trial panels, single crystal particles 27 made of magnesium oxide are dispersed and stuck on thin-film base protective layer 26a mainly made of magnesium oxide without agglomeration. The third type of trial panels are in accordance with the exemplary embodiment. In the last trial panels, single crystal particles 27 of magnesium oxide are agglomerated on thin-film base protective layer 26a mainly made of magnesium oxide, and agglomerated particles 28 are discretely stuck to the layer so as to be distributed substantially uniformly over the whole surface thereof.

The electron emission performance and charge retention performance of these three types of panels are investigated. When the electron emission performance is higher, a discharge is apt to occur and the discharge delay decreases. Thus, the discharge delay time of each of the three types of panels is measured, the statistical delay time is estimated, and numerical value K obtained by integrating the inverse of the statistical delay time is set to indicate the electron emission performance of each panel. Therefore, a panel having larger value K has higher electron emission performance.

For a panel having low charge retention performance, the scan pulse voltage applied to scan electrodes 22 to compensate the electric charge needs to be increased in a panel driving method described later. The address pulse voltage applied to data electrodes 32 also needs to be increased. Thus minimum voltage Vmin of scan pulses required for driving each panel is used as a numerical value indicating the charge retention performance. Therefore, a panel having lower voltage Vmin has higher charge retention performance.

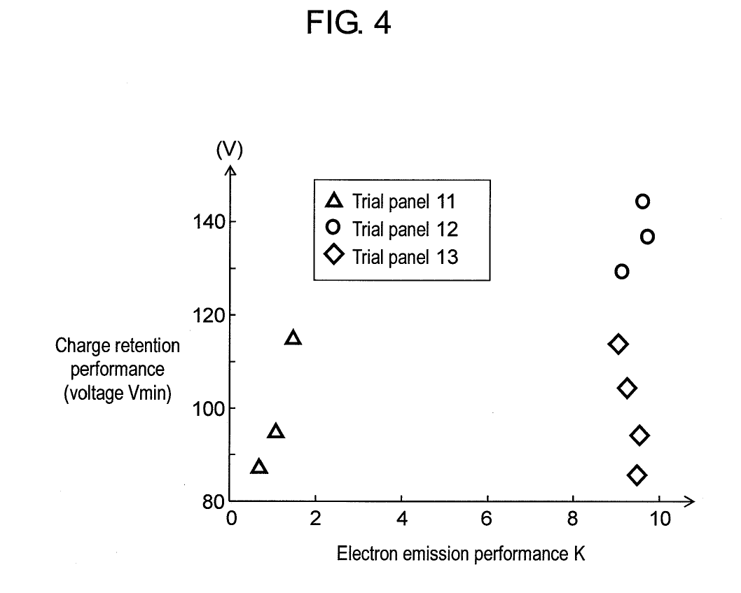

FIG. 4 is a diagram showing the electron emission performance and charge retention performance of three types of trial panels 11 through trial panels 13 including the panel of the exemplary embodiment of the present invention. The first type of trial panels 11 have low voltage Vmin and low numerical value K, and hence have high charge retention performance but low electron emission performance. The second type of trial panels 12 have high voltage Vmin and high numerical value K, and hence have high electron emission performance but low charge retention performance.

The third type of trial panels 13 of the exemplary embodiment have low voltage Vmin and high numerical value K. Therefore, trial panels 13 include panel 10 having excellent characteristics, namely high electron emission performance and high charge retention performance. Panel 10 has thus protective layer 26 that has thin-film base protective layer 26a mainly made of magnesium oxide, and particle layer 26b. In particle layer 26b, agglomerated particles 28 formed by agglomerating single crystal particles 27 of magnesium oxide are stuck on base protective layer 26a so that the agglomerated particles are distributed substantially uniformly over the whole surface thereof. Thus, a panel having excellent characteristics, namely high electron emission performance and high charge retention performance, can be provided.

Next, the particle diameter of single crystal particles 27 is described. In the following descriptions, the particle diameter means a median diameter.

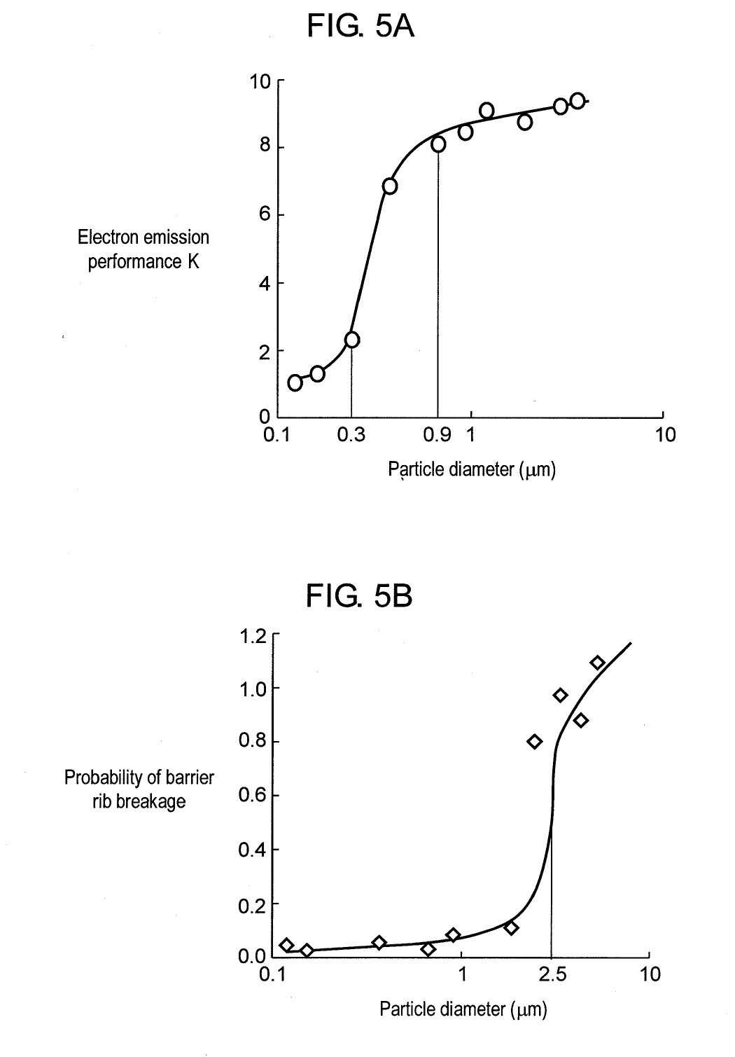

FIG. 5A is a diagram showing a result of an experiment where the diameter of single crystal particles 27 in trial panels 13 is changed and the electron emission performance is investigated. The particle diameter of single crystal particles 27 is measured through microscopic observation. According to the experiment, the electron emission performance is low when the particle diameter of single crystal particles 27 is as small as about 0.3 μm, and the electron emission performance is high when the particle diameter is about 0.9 μm or larger. However, the inventors have verified the following fact experimentally. When single crystal particles 27 having large particle diameter exist at the positions in contact with the top parts of barrier ribs 34 of back plate 30, the probability of breakage of the top parts of barrier ribs 34 increases. FIG. 5B is a diagram showing the relation between the diameter of single crystal particles 27 in trial panels 13 and the breakage of barrier ribs 34. As shown in FIG. 5B, when the particle diameter of single crystal particles 27 becomes as large as about 2.5 μm, the probability of barrier rib breakage sharply increases. When the crystal particle diameter is smaller than 2.5 μm, the probability of barrier rib breakage can be suppressed to be relatively low.

According to these results, it is considered to be preferable that the particle diameter of single crystal particles 27 is between 0.9 and 2.5 μm inclusive. However, in consideration of variation or the like in manufacturing, it is preferable to use agglomerated particles 28 formed of single crystal particles 27 having a particle diameter of the range of 0.9 to 2 μm. By forming protective layer 26 in this manner, panel 10 can be provided that has no risk of breakage of barrier ribs 34 and has excellent characteristics, namely high electron emission performance and high charge retention performance.

In the present exemplary embodiment, panel 10 that includes thin-film base protective layer 26a mainly made of magnesium oxide has been described. However, the present invention is not limited to this. Protective layer 26 is disposed to protect dielectric layer 25 from ion collision and to facilitate causing of discharge. In the present exemplary embodiment, protective layer 26 is formed of base protective layer 26a and particle layer 26b. Base protective layer 26a mainly protects dielectric layer 25, and particle layer 26b mainly facilitates causing of discharge. For this purpose, base protective layer 26a may be formed of other material including magnesium oxide containing aluminum, aluminum oxide, or metal oxide of high sputter resistance. As single crystal particles 27 forming particle layer 26b, magnesium oxide that contains strontium, calcium, barium, or aluminum may be used. Particle layer 26b may be formed of single crystal particles mainly made of strontium oxide, calcium oxide, or barium oxide.

Next, a driving method of panel 10 of the exemplary embodiment of the present invention is described.

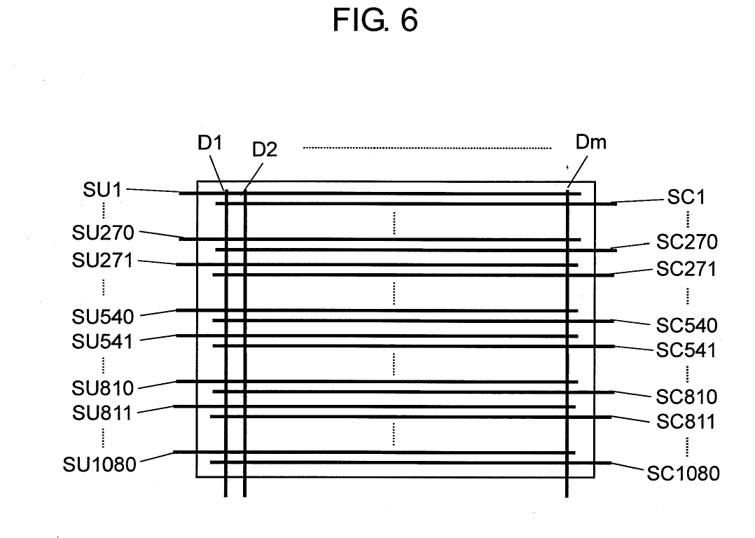

FIG. 6 is a diagram showing an electrode array of panel 10 in accordance with the exemplary embodiment of the present invention. Panel 10 has n scan electrodes SC1 through SCn (scan electrodes 22 in FIG. 1) and n sustain electrodes SU1 through SUn (sustain electrodes 23 in FIG. 1) both long in the row direction (line direction), and m data electrodes Dl through Dm (data electrodes 32 in FIG. 1) long in the column direction. A discharge cell is formed in the part where a pair of scan electrode SCi (i is 1 through n) and sustain electrode SUi intersect with one data electrode Dj (j is 1 through m). Thus, m×n discharge cells are formed in the discharge space. The number of discharge cells is represented by m=1920×3=5760 and n=1080, for example. The number of display electrode pairs is not limited specifically, but the present exemplary embodiment is described assuming n=1080.

Then, 1080 display electrode pairs formed of scan electrodes SC1 through SC1080 and sustain electrodes SU1 through SU1080 are classified into a plurality of display electrode pair groups. In the present exemplary embodiment, the panel is vertically divided into four display electrode pair groups. The four groups are referred to as a first display electrode pair group, a second display electrode pair group, a third display electrode pair group, and a fourth display electrode pair group in the order starting from the display electrode pair that is disposed at the top of the panel. In other words, scan electrodes SC1 through SC270 and sustain electrodes SU1 through SU270 belong to the first display electrode pair group. Scan electrodes SC271 through SC540 and sustain electrodes SU271 through SU540 belong to the second display electrode pair group. Scan electrodes SC541 through SC810 and sustain electrodes SU541 through SU810 belong to the third display electrode pair group. Scan electrodes SC811 through SC1080 and sustain electrodes SU811 through SU1080 belong to the fourth display electrode pair group.

Next, a driving voltage waveform to be applied to each electrode in order to drive panel 10 is described. Panel 10 is driven by a subfield method in which a plurality of subfields are temporally disposed to form one field period. In other words, one field period is divided into the plurality of subfields, and gradation display is attained by control of light emission and no light emission of each discharge cell in each subfield. In the present exemplary embodiment, in driving panel 10, a plurality of subfields are classified into two subfield groups, namely a first subfield group and a second subfield group.

Each of the subfields belonging to the first subfield group has an initializing period, an address period, and a sustain period. In the initializing period, an initializing discharge is caused to erase the history of the wall charge of the preceding discharge cell and to form wall charge for causing an address discharge. In the address period, an address discharge is caused in a discharge cell to emit light, and wall charge for causing a sustain discharge is formed. Such an address operation is hereinafter referred to as “positive-logic address”. In the sustain period, as many sustain pulses as the number corresponding to luminance weight are alternately applied to the display electrode pairs, and sustain discharge is caused in the discharge cell having undergone the positive-logic address, thereby emitting light.

In the subfields belonging to the first subfield group, by controlling the address discharge in each subfield, the discharge cell can be made to emit light or emit no light without depending on the existence or the like of a sustain discharge in the other subfields. The driving for controlling the light emission and no light emission independently in each subfield is hereinafter referred to as “random driving”.

On the other hand, each of the subfields belonging to the second subfield group has no initializing period, but has an address period and a sustain period. In the address period, an address discharge is caused in a discharge cell to emit no light, and wall charge for causing a sustain discharge is erased. Such an address operation is hereinafter referred to as “negative-logic address”. In the sustain period, as many sustain pulses as the number corresponding to luminance weight are alternately applied to the display electrode pairs, and sustain discharge is caused to emit light in the discharge cell having undergone no address discharge.

In the subfields belonging to the second subfield group, an operation for producing wall charge for causing a sustain discharge is not performed, but an operation for erasing wall charge for causing a sustain discharge in the address period is performed. Therefore, in the discharge cell where no sustain discharge has been caused in the immediately preceding subfield, a sustain discharge does not occur before the next initializing operation. While, in the discharge cell where an address operation has occurred, a sustain discharge does not occur before the next initializing operation.

As a result, in the subfields belonging to the second subfield group, subfields where light is emitted in the discharge cell are successively disposed, and subfields where light is not emitted in the discharge cell are successively disposed. Hereinafter, the driving for displaying gradation by performing control so that light emission or no light emission are successively performed in the discharge cell is simply referred to as “successive driving”.

In the present exemplary embodiment, one field is divided into 11 subfields (first SF, second SF, . . . , 11th SF). The respective subfields have luminance weights of 8, 4, 2, 1, 16, 20, 26, 32, 40, 48, and 58. The first SF through fourth SF belong to the first subfield group for performing the random driving using the positive-logic address. The fifth SF through 11th SF belong to the second subfield group for performing the successive driving using the negative-logic address. In the initializing period of the first SF belonging to the first subfield group, an all-cell initializing operation for causing an initializing discharge in all the discharge cells is performed. In the initializing period of the second SF through the fourth SF, a selective initializing operation for selectively causing an initializing discharge in the discharge cell having undergone the sustain discharge in the immediately preceding subfield is performed.

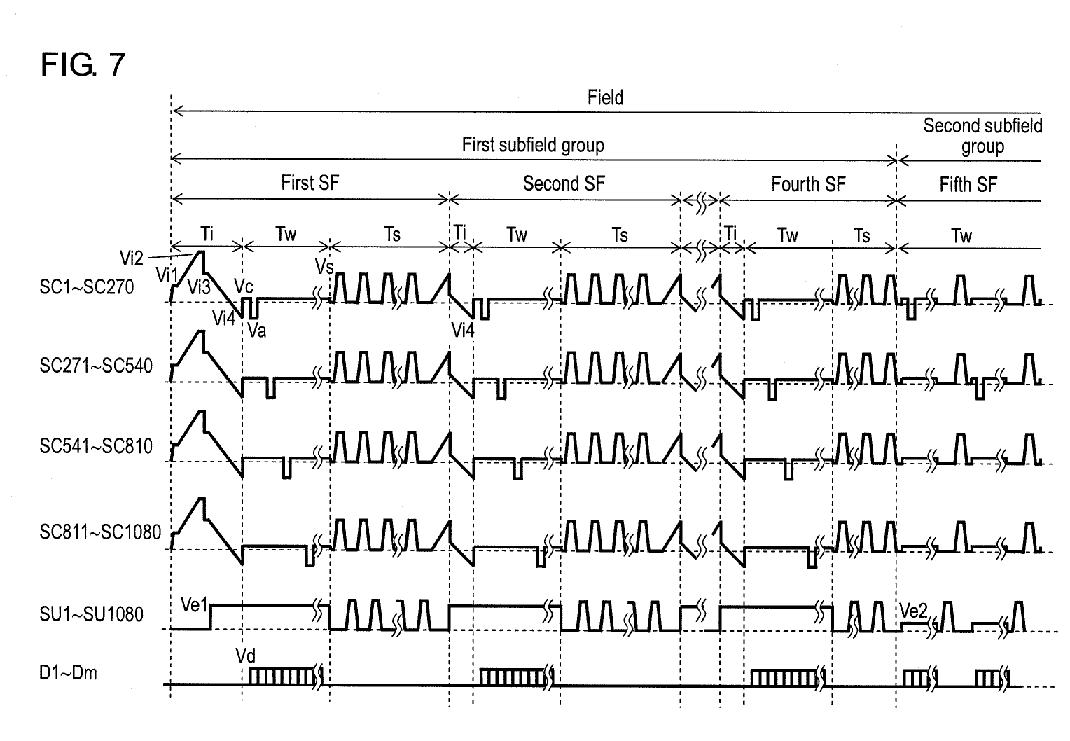

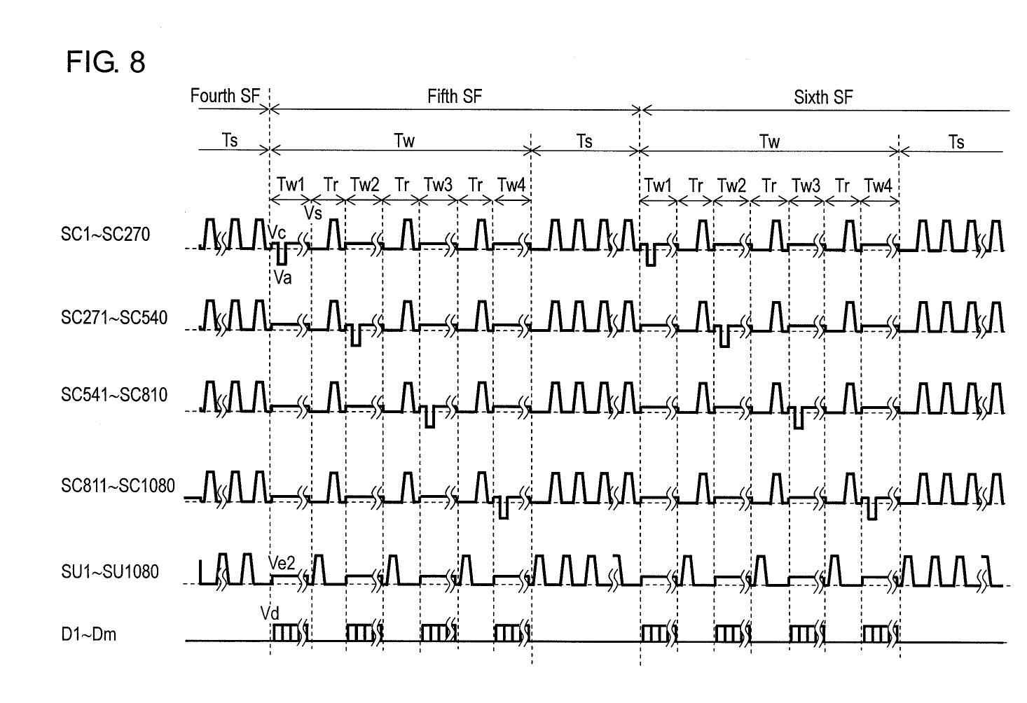

The driving method of the panel of the present embodiment is hereinafter described in detail. FIG. 7 and FIG. 8 are waveform charts of driving voltage applied to each electrode of the panel 10 of the exemplary embodiment of the present invention. FIG. 7 mainly shows the driving voltage waveforms belonging to the first subfield group, and FIG. 8 mainly shows the driving voltage waveforms belonging to the second sub-field group.

First, the driving voltage waveforms belonging to the first subfield group are described.

In the first half of initializing period Ti of the first SF, 0 (V) is applied to data electrodes D1 through Dm and sustain electrodes SU1 through SUn, and ramp waveform voltage is applied to scan electrodes SC1 through SCn. Here, the ramp waveform voltage gradually increases from voltage Vi1, which is not higher than a discharge start voltage, to voltage Vi2, which is higher than the discharge start voltage, with respect to sustain electrodes SU1 through SUn.

While the ramp waveform voltage increases, a feeble initializing discharge occurs between scan electrodes SC1 through SCn and sustain electrodes SU1 through SUn, and a feeble initializing discharge occurs between scan electrodes SC1 through SCn and data electrodes D1 through Dm. Negative wall voltage is accumulated on scan electrodes SC1 through SCn, and positive wall voltage is accumulated on data electrodes D1 through Dm and sustain electrodes SU1 through SUn. Here, the wall voltage on the electrodes represents the voltage generated by the wall charges accumulated on the dielectric layer covering the electrodes, on the protective layer, and on the phosphor layer. In the initializing discharge at this time, excessive wall voltage is accumulated in expectation of optimizing the wall voltage in the latter half of initializing period Ti.

In the latter half of initializing period Ti, voltage Ve1 is applied to sustain electrodes SU1 through SUn, and ramp waveform voltage is applied to scan electrodes SC1 through SCn. Here, the ramp waveform voltage gradually decreases from voltage Vi3, which is not higher than the discharge start voltage, to voltage Vi4, which is higher than the discharge start voltage, with respect to sustain electrodes SU1 through SUn. While the ramp waveform voltage decreases, a feeble initializing discharge occurs between scan electrodes SC1 through SCn and sustain electrodes SU1 through SUn, and a feeble initializing discharge occurs between scan electrodes SC1 through SCn and data electrodes D1 through Dm. The negative wall voltage on scan electrodes SC1 through SCn and the positive wall voltage on sustain electrodes SU1 through SUn are decreased, and the positive wall voltage on data electrodes D1 through Dm is regulated to a value appropriate to the address operation. Thus, the all-cell initializing operation of applying the initializing discharge to all the discharge cells is completed.

In subsequent address period Tw, voltage Ve1 is applied to sustain electrodes SU1 through SUn, and voltage Vc is applied to scan electrodes SC1 through SCn.

Next, negative scan pulse voltage Va is applied to scan electrode SC1 in the first line, positive address pulse voltage Vd is applied to data electrode Dk (k is 1 through m) in the discharge cell to emit light in the first line, among data electrodes D1 through Dm. At this time, the voltage difference in the intersecting part of data electrode Dk and scan electrode SC1 is derived by adding the difference between the wall voltage on data electrode Dk and that on scan electrode SC1 to the difference (Vd−Va) between the external applied voltages, and exceeds the discharge start voltage. An address discharge thus occurs between data electrode Dk and scan electrode SC1 and between sustain electrode SU1 and scan electrode SC1, positive wall voltage is accumulated on scan electrode SC1, negative wall voltage is accumulated on sustain electrode SU1, and negative wall voltage is accumulated also on data electrode Dk.

The time since the application of scan pulse voltage Va and address pulse voltage Vd until the occurrence of the address discharge is referred to as “discharge delay time”. If the electron emission performance of the panel is low and the discharge delay time is long, the time period when scan pulse voltage Va and address pulse voltage Vd are applied, namely scan pulse width and address pulse width, is required to be set long in order to certainly perform the address operation, and a high-speed address operation cannot be performed. If the charge retention performance of the panel is low, the values of scan pulse voltage Va and address pulse voltage Vd are required to be set high in order to compensate for the reduction in wall voltage. However, panel 10 of the present embodiment has high electron emission performance, so that the scan pulse width and address pulse width can be set shorter than those of the conventional panel and high-speed address operation can be stably performed. Panel 10 of the present embodiment has high charge retention performance, so that the values of scan pulse voltage Va and address pulse voltage Vd can be set lower than those of the conventional panel.

Thus, a positive-logic address operation of causing an address discharge in the discharge cell to emit light in the first line and accumulating wall charge required for a sustain discharge is performed. The voltage in the part where scan electrode SC1 intersects with data electrodes D1 through Dm applied with no address pulse voltage Vd does not exceed the discharge start voltage, so that an address discharge does not occur. This positive-logic address operation is repeated until it reaches the discharge cell in the n-th line, and address period Tw is completed.

In subsequent sustain period Ts, firstly, positive sustain pulse voltage Vs is applied to scan electrodes SC1 through SCn, and 0 (V) is applied to sustain electrodes SU1 through SUn. In the discharge cell having undergone the positive-logic address, the voltage difference between scan electrode SCi and sustain electrode SUi is obtained by adding the difference between the wall voltage on scan electrode SCi and that on sustain electrode SUi to sustain pulse voltage Vs, and exceeds the discharge start voltage.

A sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is accumulated also on data electrode Dk. In the discharge cell having undergone no positive logic address in address period Tw, a sustain discharge does not occur and wall voltage at the end of initializing period Ti is maintained.

Then, 0 (V) is applied to scan electrodes SC1 through SCn, and sustain pulse voltage Vs is applied to sustain electrodes SU1 through SUn. In the discharge cell having undergone the sustain discharge, the voltage difference between scan electrode SCi and sustain electrode SUi exceeds the discharge start voltage. Therefore, a sustain discharge occurs between sustain electrode SUi and scan electrode SCi again, negative wall voltage is accumulated on sustain electrode SUi, and positive wall voltage is accumulated on scan electrode SCi. Hereinafter, similarly, as many sustain pulses as the number corresponding to the luminance weight are alternately applied to scan electrodes SC1 through SCn and sustain electrodes SU1 through SUn, thereby applying potential difference between the electrodes of the display electrode pairs. Thus, a sustain discharge successively occurs in the discharge cell having undergone positive-logic address.

At the end of sustain period Ts, up-ramp waveform voltage is applied to scan electrodes SC1 through SCn to erase wall voltage on scan electrode SCi and sustain electrode SUi while the positive wall voltage on data electrode Dk is maintained.

In subsequent initializing period Ti of the second SF, voltage Ve1 is applied to sustain electrodes SU1 through SUn and 0 (V) is applied to data electrodes D1 through Dm, and down-ramp waveform voltage gradually decreasing to voltage Vi4 is applied to scan electrodes SC1 through SCn. In the immediately preceding subfield, then, a feeble initializing discharge occurs in the discharge cell having undergone the sustain discharge, and the wall voltages on scan electrode SCi and sustain electrode SUi are decreased. Sufficient positive wall voltage is accumulated on electrode Dk by the immediately preceding sustain discharge, so that excessive part of the wall voltage is discharged to regulate it to a wall voltage appropriate to the address operation.

In the discharge cell having undergone no sustain discharge in the immediately preceding subfield, a discharge does not occur and the wall charge at the end of the initializing period of the preceding subfield is maintained. Thus, the initializing period of the second SF is a selective initializing operation of selectively applying initializing discharge to the discharge cell having undergone the sustain operation in the sustain period in the immediately preceding subfield.

The operation of subsequent address period Tw is the same as that of address period Tw in the first SF, and thus the description thereof is omitted. The operation of subsequent sustain period Ts is also the same as that of sustain period Ts of the first SF except for the number of sustain pulses. The operation of the subsequent third SF is also the same as that of the second SF except for the number of sustain pulses. The operations of initializing period Ti and address period Tw in the fourth SF are the same as those in the second SF.

In sustain period Ts of the fourth SF, as in sustain periods Ts in the first SF through third SF, as many sustain pulses as the number corresponding to luminance weight are alternately applied to scan electrodes SC1 through SCn and sustain electrodes SU1 through SUn, thereby applying potential difference between the electrodes of each display electrode pair. Thus, the sustain discharge is successively performed in the discharge cell having undergone the positive-logic address.

At the end of sustain period Ts of the fourth SF, sustain pulse voltage Vs is applied to scan electrodes SC1 through SCn and 0 (V) is applied to sustain electrodes SU1 through SUn, thereby causing a sustain discharge in the discharge cell having undergone the address discharge. Negative wall voltage is accumulated on scan electrode SCi, positive wall voltage is accumulated on sustain electrode SUi, and positive wall voltage is accumulated also on data electrode Dk. Sustain period Ts of the fourth SF is completed in this state.

Thus, in sustain period Ts of the last subfield of the first subfield group, the wall voltage on scan electrode SCi and sustain electrode SUi are not erased. Sustain period Ts is completed in the state where negative wall voltage is accumulated on scan electrode SCi and positive wall voltage is accumulated on sustain electrode SUi. The wall voltage is used for causing a sustain discharge in the subfield of the subsequent second subfield group.

No wall voltage is accumulated on scan electrode SCi and sustain electrode SUi of the discharge cell having undergone no sustain discharge in the fourth SF. Therefore, in the discharge cell having undergone no sustain discharge in the fourth SF, a sustain discharge is not caused even in the fifth SF through 11th SF of the subsequent second subfield group.

Next, driving voltage waveforms of the subfields belonging to the second sub-field group are described with reference to FIG. 8. In the subfields belonging to the second subfield group, address period Tw is divided into four address sub-periods (first sub-period Tw1, second sub-period Tw2, third sub-period Tw3, and fourth sub-period Tw4) corresponding to the four display electrode pair groups. A replenish sub-period Tr for replenishing wall charge is disposed between one address sub-period and its next address sub-period.

In first period Tw1 of address period Tw in the fifth SF, voltage Ve2 is applied to sustain electrodes SU1 through SUn, and voltage Vc is applied to scan electrodes SC1 through SCn. Scan pulse voltage Va is applied to scan electrode SC1 in the first line, and address pulse voltage Vd is applied to data electrode Dh (h is 1 through m) in the discharge cell where light is not emitted in the first line, among data electrodes D1 through Dm. An address discharge then occurs between data electrode Dh and scan electrode SC1 and between sustain electrode SU1 and scan electrode SC1, thereby erasing the wall voltage on scan electrode SC1 and the wall voltage on sustain electrode SU1. Erasing wall voltage means that wall voltage is decreased enough to cause no sustain discharge in the sustain period described later.

The above-mentioned negative-logic address is repeated until it reaches the discharge cell in the 270th line, which belongs to the first display electrode pair group. The discharge delay time in the negative-logic address operation can be set short, and the scan pulse width and the address pulse width can be set shorter than those of the conventional panel. This allows stable and high speed address operation.

In subsequent replenish sub-period Tr, firstly, 0 (V) is applied to scan electrodes SC1 through SCn, and sustain pulse voltage Vs is applied to sustain electrodes SU1 through SUn. A discharge then occurs between scan electrode SCi and sustain electrode SUi in the discharge cell where a sustain discharge has occurred in the immediately preceding fourth SF and the negative-logic address has not been performed in first period Tw1 of the fifth SF. The discharge (hereinafter referred to as “replenish discharge”) in replenish sub-period Tr is similar to the sustain discharge, and positive wall charge is replenished on the data electrode of the discharge cell having undergone the replenish discharge. Subsequently, sustain pulse voltage Vs is applied to scan electrodes SC1 through SCn, and 0 (V) is applied to sustain electrodes SU1 through SUn. Replenish discharge then occurs again between scan electrode SCi and sustain electrode SUi.

In subsequent second period Tw2, the negative-logic address operation is performed in the discharge cells in the 271st line through 540th line, which belong to the second display electrode pair group. In subsequent replenish sub-period Tr, a replenish discharge is caused to replenish wall charge on the data electrodes. In subsequent third period Tw3, the negative-logic address operation is performed in the discharge cells in the 541st line through 810th line, which belong to the third display electrode pair group. In subsequent replenish sub-period Tr, a replenish discharge is caused to replenish wall charge. In subsequent fourth period Tw4, the negative-logic address operation is performed in the discharge cells in the 811th line through 1080th line, which belong to the fourth display electrode pair group. Thus, address period Tw of fifth SF is completed.

It is recognized that panel 10 of the present embodiment has high charge retention performance but the negative-logic address operation decreases the wall charge. If the negative-logic address operation is successively performed for n lines without disposing replenish sub-period Tr, the wall voltage is decreased by decrease in wall charge, and the values of scan pulse voltage Va and address pulse voltage Vd need to be increased. In the present embodiment, however, replenish sub-period Tr is disposed and wall charge on the data electrodes is replenished whenever negative-logic address for ¼ of all lines is performed. Therefore, the wall voltage does not significantly decrease, and hence the values of scan pulse voltage Va and address pulse voltage Vd can be set low.

In subsequent sustain period Ts, firstly, 0 (V) is applied to scan electrodes SC1 through SCn, and sustain pulse voltage Vs is applied to sustain electrodes SU1 through SUn. A sustain discharge then occurs to emit light in the discharge cell where a sustain discharge has been caused in the immediately preceding subfield and the negative-logic address has not been performed. Positive wall voltage is accumulated on scan electrode SCi, and negative wall voltage is accumulated on sustain electrode SUi. While, no sustain discharge occurs in the discharge cell where a sustain discharge has not been caused in the immediately preceding subfield or in the discharge cell where the negative-logic address has been performed in the address period.

Next, sustain pulse voltage Vs is applied to scan electrodes SC1 through SCn, and 0 (V) is applied to sustain electrodes SU1 through SUn. In the discharge cell having undergone the sustain discharge, the voltage difference between scan electrode SCi and sustain electrode SUi exceeds the discharge start voltage, so that a sustain discharge occurs again, negative wall voltage is accumulated on scan electrode SCi, and positive wall voltage is accumulated on sustain electrode SUi.

Thereafter, similarly, as many sustain pulses as the number corresponding to luminance weight are alternately applied to sustain electrodes SU1 through SUn and scan electrodes SC1 through SCn, thereby applying potential difference between the electrodes of each display electrode pair. Thus, the sustain discharge is successively performed in the discharge cell having undergone no address discharge in the address period.

The operations in the sixth SF through the 11th SF are similar to that in the fifth SF except for the number of sustain pulses.

In the present exemplary embodiment, voltage Vi1 applied to scan electrodes SC1 through SCn is 120 (V), voltage Vi2 is 350 (V), voltage Vi3 is 210 (V), voltage Vi4 is −105 (V), voltage Vc is 0 (V), voltage Va is −120 (V), and voltage Vs is 210 (V). Voltage Ve1 applied to sustain electrodes SU1 through SUn is −140 (V), voltage Ve2 is 50 (V), and voltage Vs is 210 (V). Voltage Vd applied to data electrodes D1 through Dm is 60 (V). The gradient of the up-ramp waveform voltage applied to scan electrodes SC1 through SCn is 1.0 V/μ, and the gradient of the down-ramp waveform voltage is −1.3 V/μ. Both the scan pulse width and the address pulse width are 1.0 μs. However, these voltages are not limited to the above-mentioned values. It is preferable to set optimum values according to the discharge characteristic of the panel and the specification of the plasma display device.

As discussed above, protective layer 26 of panel 10 of the present embodiment has base protective layer 26a and particle layer 26b. Base protective layer 26a is formed of a thin film containing magnesium oxide. Particle layer 26b is formed by discretely sticking, to the whole surface of base protective layer 26a, agglomerated particles 28 where a plurality of single crystal particles of magnesium oxide are agglomerated. Therefore, panel 10 has high electron emission performance and high charge retention performance. The panel driving circuit classifies a plurality of subfields forming one field period into two subfield groups, and temporally disposes the second subfield group after the first subfield group. Each of the subfields belonging to the first subfield group has an initializing period for producing wall charge for causing an address discharge, an address period for producing wall charge for causing a sustain discharge, and a sustain period for causing a sustain discharge to emit light in the discharge cell. In this subfield, the random driving is performed using the positive-logic address. Each of the subfields belonging to the second subfield group has an address period for erasing wall charge for a sustain discharge, and a sustain period for causing a sustain discharge to emit light in the discharge cell. In this subfield, the successive driving is performed using the negative-logic address.

In the present embodiment, the address period is shortened using the performance of panel 10 that has the high electron emission performance and can be driven at high speed, and the number of subfields in the second subfield group for performing the successive driving is sufficiently secured, thereby achieving image display without false contour. Smooth gradation display is achieved by further using the first subfield group for performing the random driving. In the subfields belonging to the second subfield group, the address period is divided into a plurality of address sub-periods corresponding to a plurality of display electrode pair groups, and a replenish sub-period for replenishing wall charge is disposed between one address sub-period and its next address sub-period to replenish the wall charge on the data electrodes. Therefore, the values of scan pulse voltage Va and address pulse voltage Vd can be set low.

In the present exemplary embodiment, one field is divided into 11 subfields (first SF, second SF, . . . , 11th SF). The respective subfields have luminance weights of 8, 4, 2, 1, 16, 20, 26, 32, 40, 48, and 58. The first SF through fourth SF belong to the first subfield group for performing random driving using the positive-logic address. The fifth SF through 11th SF belong to the second subfield group for performing the successive driving using the negative-logic address. However, the subfield structure such as the number of subfields and luminance weight is not limited to this, and it is preferable to optimally set the structure according to the characteristic of the panel and specification of the plasma display device.

In the present embodiment, sustain pulses are applied to the display electrode pairs in the sustain period in each subfield. However, a subfield having a sustain period when a sustain pulse is not applied may be disposed. In other words, in the sustain period, no sustain pulse is applied to the display electrode pairs, sustain pulse voltage Vs is applied to scan electrodes SC1 through SCn, and 0 (V) is applied to sustain electrodes SU1 through SUn, thereby erasing wall voltage in the discharge cell having undergone an address discharge. Thus, even when an image is dark, smooth image display thereof is allowed.

In the present embodiment, the subfields belonging to the first subfield group are arranged so that the luminance weight decreases monotonically. The present invention is not limited to this. However, the inventors have demonstrated that the discharge delay time of the address discharge is shortened by arranging the subfields so that the luminance weight decreases monotonically.

Next, one example of the driving circuits for generating the driving voltage waveforms having been described in the exemplary embodiment is described.

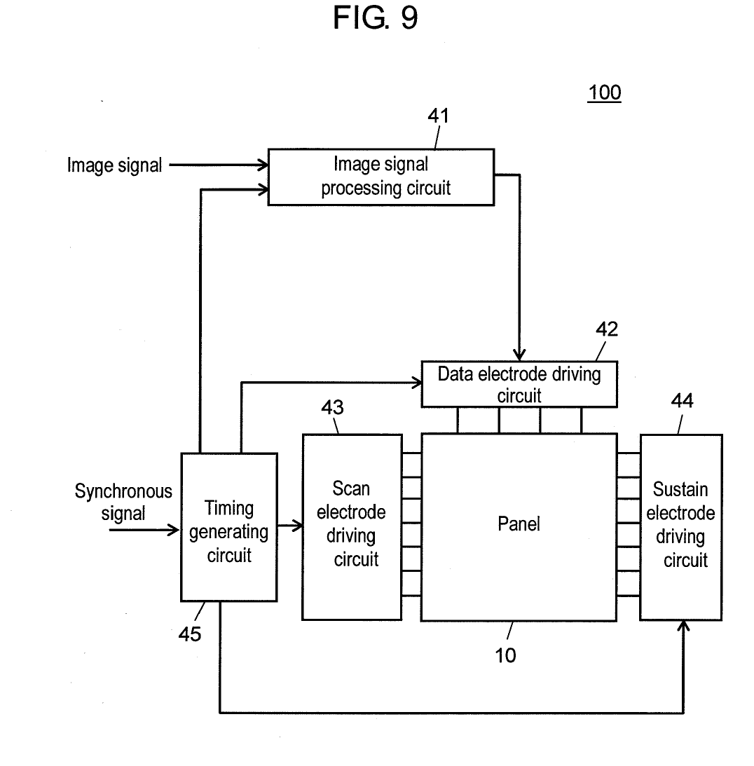

FIG. 9 is a circuit block diagram of plasma display device 100 in accordance with the exemplary embodiment of the present invention. Plasma display device 100 has panel 10 and a panel driving circuit. The panel driving circuit has the following elements:
image signal processing circuit 41;
data electrode driving circuit 42;
scan electrode driving circuit 43;
sustain electrode driving circuit 44;
timing generating circuit 45; and
a power supply circuit (not shown) for supplying power required for each circuit block.

Image signal processing circuit 41 converts an input image signal into image data that indicates light emission or no light emission in each subfield. Data electrode driving circuit 42 converts the image data in each subfield into a signal corresponding to each of data electrodes D1 through Dm, and drives each of data electrodes D1 through Dm. Timing generating circuit 45 generates various timing signals for controlling operations of respective circuit blocks based on a horizontal synchronizing signal and a vertical synchronizing signal, and supplies them to respective circuit blocks. Scan electrode driving circuit 43 drives each of scan electrodes SC1 through SCn based on a timing signal, and sustain electrode driving circuit 44 drives sustain electrodes SU1 through SUn based on a timing signal.

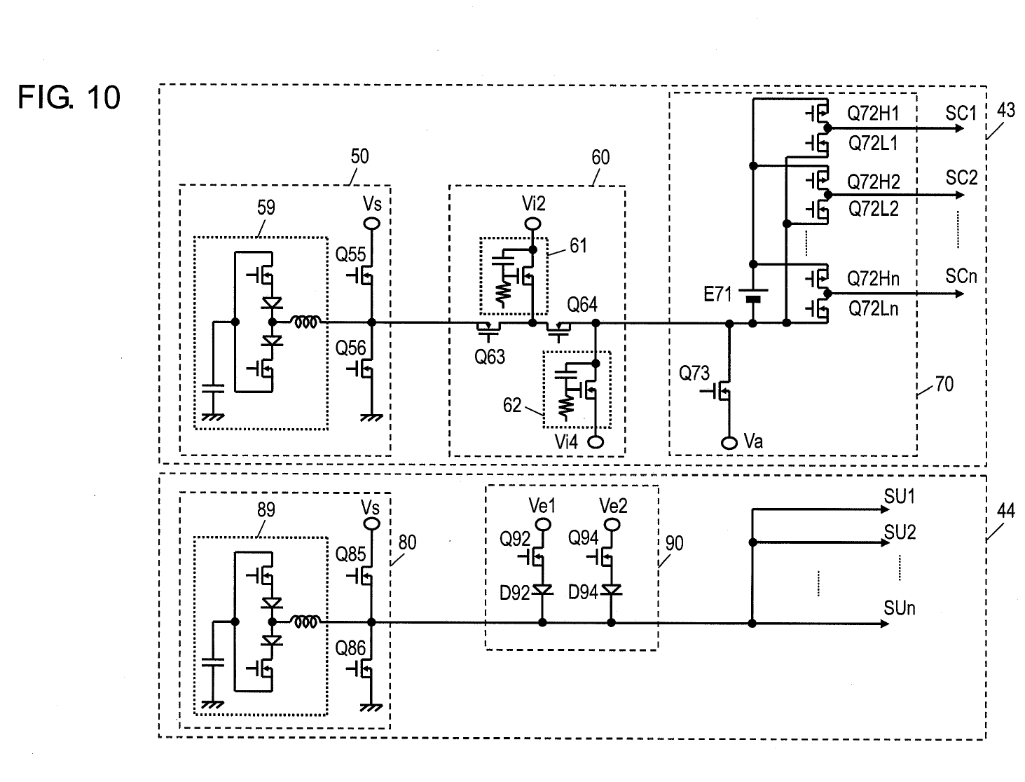

FIG. 10 is a circuit diagram of scan electrode driving circuit 43 and sustain electrode driving circuit 44 of plasma display device 100 in accordance with the exemplary embodiment of the present invention.

Scan electrode driving circuit 43 has sustain pulse generating circuit 50, initializing waveform generating circuit 60, and scan pulse generating circuit 70. Sustain pulse generating circuit 50 has the following elements:
switching element Q55 for applying voltage Vs to scan electrodes SC1 through SCn;
switching element Q56 for applying 0 (V) to scan electrodes SC1 through SCn;
electric power recovering section 59 for recovering electric power when a sustain pulse is applied to scan electrodes SC1 through SCn.
   Initializing waveform generating circuit 60 has Miller integrating circuit 61 for applying up-ramp waveform voltage to scan electrodes SC1 through SCn, and Miller integrating circuit 62 for applying down-ramp waveform voltage to scan electrodes SC1 through SCn. Switching element Q63 and switching element Q64 prevent current from flowing backward through a parasitic diode or the like of another switching element. Scan pulse generating circuit 70 has the following elements:
floating power supply E71;
switching elements Q72H1 through Q72Hn and Q72L1 through Q72Ln for applying voltage on the high voltage side of floating power supply E71 or voltage on the low voltage side thereof to respective scan electrodes SC1 through SCn; and
switching element Q73 for fixing the voltage on the low voltage side of floating power supply E71 to voltage Va.

Sustain electrode driving circuit 44 has sustain pulse generating circuit 80, and initializing/address voltage generating circuit 90. Sustain pulse generating circuit 80 has the following elements:
switching element Q85 for applying voltage Vs to sustain electrodes SU1 through SUn;
switching element Q86 for applying 0 (V) to sustain electrodes SU1 through SUn; and
electric power recovering section 89 for recovering electric power when a sustain pulse is applied to sustain electrodes SU1 through SUn.
   Initializing/address voltage generating circuit 90 has the following elements:
switching element Q92 and diode D92 for applying voltage Ve1 to sustain electrodes SU1 through SUn; and
switching element Q94 and diode D94 for applying voltage Ve2 to sustain electrodes SU1 through SUn.

These switching elements can be formed of generally known elements such as a metal oxide semiconductor field effect transistor (MOSFET) and an insulated gate bipolar transistor (IGBT). Each of these switching elements is controlled by a timing signal corresponding to the switching element generated by timing generating circuit 45.

The driving circuit shown in FIG. 10 is an example of circuitry for generating the driving voltage waveforms of FIG. 7 and FIG. 8. The plasma display device of the present invention is not limited to this circuitry.

Each of the specific numerical values used in the embodiment is simply one example. Preferably, they are set to optimal values appropriately in response to the characteristic of the panel and the specification of the plasma display device.

### INDUSTRIAL APPLICABILITY

The plasma display device of the present invention performs high-speed and stable address operation, and can display an image of high image display quality allowing smooth gradation display without false contour. Therefore, this plasma display device can be used as a display device.

1. A plasma display device comprising:
a plasma display panel including:
a front plate having display electrode pairs on a first glass substrate, a dielectric layer for covering the display electrode pairs, and a protective layer on the dielectric layer;
a back plate having data electrodes on a second glass substrate, the back plate being faced to the front plate; and
discharge cells formed at positions where the display electrode pairs face the data electrodes; and
a panel driving circuit for driving the plasma display panel while a plurality of subfields are temporally disposed to form one field period,
wherein the protective layer has:
a base protective layer formed of a thin film containing metal oxide; and
a particle layer formed by sticking agglomerated particles to the base protective layer, each of the agglomerated particles being formed by agglomerating a plurality of single crystal particles of magnesium oxide, and
wherein the panel driving circuit drives the plasma display panel by forming one field period, the one field period being formed by temporally arranging a second subfield group after a first subfield group,
wherein the first subfield group has a plurality of subfields each of which has an initializing period for producing wall charge for causing an address discharge, an address period for producing wall charge for causing a sustain discharge, and a sustain period for causing a sustain discharge to emit light in the discharge cells, and
wherein the second subfield group has a plurality of subfields each of which has an address period for erasing wall charge for causing a sustain discharge and a sustain period for causing a sustain discharge to emit light in the discharge cells.

2. The plasma display device of claim 1, wherein
the panel driving circuit
classifies the display electrode pairs into a plurality of display electrode pair groups,
divides an address period of a subfield belonging to the second subfield group into a plurality of address sub-periods correspondingly to the plurality of display electrode pair groups,
disposes a replenish sub-period for replenishing wall charge between one address sub-period and a next address sub-period, and
drives the plasma display panel.
